(19) United States
(12) Patent Application Publication
(10) Pub. No.: US 2024/0422779 A1
(43) Pub. Date: Dec. 19, 2024

(54) METHOD FOR TRANSMITTING AND RECEIVING SIGNALS IN WIRELESS COMMUNICATION SYSTEM, AND DEVICE SUPPORTING SAME

(71) Applicant: LG Electronics Inc., Seoul (KR)

(72) Inventors: Kukheon CHOI, Seoul (KR); Byungwoon JUNG, Seoul (KR); Woocheol CHOI, Seoul (KR); Uisheon KIM, Seoul (KR)

(21) Appl. No.: 18/698,589

(22) PCT Filed: Oct. 5, 2022
(86) PCT No.: PCT/KR2022/014961

§ 371 Date: Apr. 4, 2024

(30) Foreign Application Priority Data
Oct. 5, 2021 (KR) 10-2021-0131630

(51) Int. Cl. H04W 72/20; H04L 5/00

(52) U.S. Cl. CPC H04W 72/20; H04L 5/0053

(57) ABSTRACT

One embodiment relates to a next generation wireless communication system for supporting a higher data transmission rate than a 4th generation (4G) wireless communication system. According to one embodiment, a method for transmitting and receiving signals in a wireless communication system and a device supporting same may be provided, and another embodiment may be provided. A sequence generator related to generation of signals in a wireless communication system may be initialized on the basis of an OAM state of OAM-based communication. In addition, communication of the signals may be performed on the basis of the OAM-based communication.

### TECHNICAL FIELD

Embodiments relate to a wireless communication system.

### BACKGROUND ART

As a number of communication devices have required higher communication capacity, the necessity of the mobile broadband communication much improved than the existing radio access technology (RAT) has increased. In addition, massive machine type communications (MTC) capable of providing various services at anytime and anywhere by connecting a number of devices or things to each other has been considered in the next generation communication system. Moreover, a communication system design capable of supporting services/UEs sensitive to reliability and latency has been discussed.

### DISCLOSURE

### Technical Problem

The embodiment may provide a method and apparatus for transmitting and receiving a signal in a wireless communication system.

It will be appreciated by persons skilled in the art that the objects that could be achieved with the embodiment are not limited to what has been particularly described hereinabove and the above and other objects that the embodiment could achieve will be more clearly understood from the following detailed description.

### Technical Solution

In an embodiment, provided herein are a method of transmitting and receiving signals in a wireless communication system and apparatus supporting the same.

According to one embodiment, a method performed by a user equipment (UE) in a wireless communication system may be provided.

According to one embodiment, the method may include receiving configuration information.

According to one embodiment, the configuration information may include one or more of system information, scheduling information, channel state information (CSI)-related configuration information, a physical uplink control channel (PUCCH)-related configuration, a physical uplink shared channel (PUSCH)-related configuration, a physical downlink control channel (PDCCH)-related configuration, or a physical downlink shared channel (PDSCH)-related configuration.

According to one embodiment, the method may include communicating a signal based on the configuration information.

According to one embodiment, the signal may be communicated based on orbital angular momentum (OAM) based communication.

According to one embodiment, a sequence generator related to generation of the signal may be initialized based on the OAM state of the OAM based communication.

According to one embodiment, the configuration information may include configuration information for the OAM based communication.

According to one embodiment, the configuration information for the OAM based communication may include one or more of resource configuration for the OAM based communication or information related to the OAM state.

According to one embodiment, the information related to the OAM state may include one or more of a total number of OAM states of a base station having transmitted the configuration information, a maximum number of orthogonal OAM states of the base station, a set of OAM states of the base station, a subset of OAM states of the base station, the number of ring arrays of the base station, the number of ports of the ring arrays of the base station, or a transmission mode of the base station.

According to one embodiment, the method may include measuring the OAM state based on one or more resources for the OAM based communication.

According to one embodiment, the method may include transmitting feedback information including the information related to the OAM state.

According to one embodiment, the method may further include transmitting UE capability information related to whether the UE supports the OAM based communication.

According to one embodiment, based on that the terminal capability information corresponds to the terminal supporting the OAM based communication, the signal may be communicated.

According to one embodiment, the OAM state may be indicated by four-bit information.

According to one embodiment, based on the signal being a data channel, the data channel may be initialized based on a radio network temporary identifier (RNTI) related to transmission of the data channel, the OAM state, and a parameter that is configured by a higher layer or preconfigured.

According to one embodiment based on the sequence generator corresponding to a Zadoff Chu (ZC) sequence, one or more of a group number or a base sequence number of the ZC sequence may be determined based on the OAM state.

According to one embodiment, based on a value of a most significant bit (MSB) of a specific bit sequence being a specific value, one or more of the group number or base sequence number of the ZC sequence may be determined based on the OAM state.

According to one embodiment, a terminal operating in a wireless communication system may be provided.

According to one embodiment, the terminal may include a transceiver; and one or more processors connected to the transceiver.

According to one embodiment, the one or more processors may be configured to receive configuration information.

According to one embodiment, the configuration According to one embodiment, information may include one or more of system information, scheduling information, channel state information (CSI)-related configuration information, a physical uplink control channel (PUCCH)-related configuration, a physical uplink shared channel (PUSCH)-related configuration, a physical downlink control channel (PDCCH)-related configuration, or a physical downlink shared channel (PDSCH)-related configuration.

According to one embodiment, the one or more processors may be configured to communicate a signal based on the configuration information.

According to one embodiment, the signal may be communicated based on orbital angular momentum (OAM) based communication.

According to one embodiment, a sequence generator related to generation of the signal may be initialized based on the OAM state of the OAM based communication.

According to one embodiment, the configuration information may include configuration information for the OAM based communication.

According to one embodiment, the configuration information for the OAM based communication may include one or more of resource configuration for the OAM based communication or information related to the OAM state.

According to one embodiment, the information related to the OAM state may include one or more of a total number of OAM states of a base station having transmitted the configuration information, a maximum number of orthogonal OAM states of the base station, a set of OAM states of the base station, a subset of OAM states of the base station, the number of ring arrays of the base station, the number of ports of the ring arrays of the base station, or a transmission mode of the base station.

According to one embodiment, the one or more processors may be configured to communicate with one or more of a mobile terminal, a network, or an autonomous vehicle other than a vehicle containing the terminal.

According to one embodiment, a method performed by a base station in a wireless communication system may be provided.

According to one embodiment, the method may include transmitting configuration information.

According to one embodiment, the configuration According to one embodiment, information may include one or more of system information, scheduling information, channel state information (CSI)-related configuration information, a physical uplink control channel (PUCCH)-related configuration, a physical uplink shared channel (PUSCH)-related configuration, a physical downlink control channel (PDCCH)-related configuration, or a physical downlink shared channel (PDSCH)-related configuration.

According to one embodiment, the method may include: communicating a signal related to the configuration information.

According to one embodiment, the signal may be communicated based on orbital angular momentum (OAM) based communication.

According to one embodiment, a sequence generator related to generation of the signal may be initialized based on the OAM state of the OAM based communication.

According to one embodiment, a base station operating in a wireless communication system may be provided.

According to one embodiment, the base station may include a transceiver, and one or more processors connected to the transceiver.

According to one embodiment, the one or more processors may be configured to transmit configuration information.

According to one embodiment, the configuration According to one embodiment, information may include one or more of system information, scheduling information, channel state information (CSI)-related configuration information, a physical uplink control channel (PUCCH)-related configuration, a physical uplink shared channel (PUSCH)-related configuration, a physical downlink control channel (PDCCH)-related configuration, or a physical downlink shared channel (PDSCH)-related configuration.

According to one embodiment, the one or more processors may be configured to communicate a signal related to the configuration information.

According to one embodiment, the signal may be communicated based on orbital angular momentum (OAM) based communication.

According to one embodiment, a sequence generator related to generation of the signal may be initialized based on the OAM state of the OAM based communication.

According to one embodiment, an apparatus operating in a wireless communication system may be provided.

According to one embodiment, the apparatus may include one or more processors, and one or more memories operably connected to the one or more processors and storing one or more instructions that, when executed, cause the one or more processors to perform operations.

According to one embodiment, the operations may include receiving configuration information.

According to one embodiment, the configuration According to one embodiment, information may include one or more of system information, scheduling information, channel state information (CSI)-related configuration information, a physical uplink control channel (PUCCH)-related configuration, a physical uplink shared channel (PUSCH)-related configuration, a physical downlink control channel (PDCCH)-related configuration, or a physical downlink shared channel (PDSCH)-related configuration.

According to one embodiment, the operations may include communicating a signal based on the configuration information.

According to one embodiment, the signal may be communicated based on orbital angular momentum (OAM) based communication.

According to one embodiment, a sequence generator related to generation of the signal may be initialized based on the OAM state of the OAM based communication.

According to one embodiment, a non-transitory processor-readable medium storing one or more instructions that cause one or more processors to perform operations may be provided.

According to one embodiment, the operations may include receiving configuration information.

According to one embodiment, the configuration According to one embodiment, information may include one or more of system information, scheduling information, channel state information (CSI)-related configuration information, a physical uplink control channel (PUCCH)-related configuration, a physical uplink shared channel (PUSCH)-related configuration, a physical downlink control channel (PDCCH)-related configuration, or a physical downlink shared channel (PDSCH)-related configuration.

According to one embodiment, the operations may include communicating a signal based on the configuration information.

According to one embodiment, the signal may be communicated based on orbital angular momentum (OAM) based communication.

According to one embodiment, a sequence generator related to generation of the signal may be initialized based on the OAM state of the OAM based communication.

The above-described embodiments are merely a part of the embodiments, and various embodiments reflecting the technical features of the embodiments may be derived and understood by those skilled in the art based on the detailed description below.

### Advantageous Effects

According to an embodiment, a signal may be effectively transmitted and received in a wireless communication system.

According to one embodiment, signaling overhead in OAM communication may be reduced.

Advantages effects that may be obtained from the embodiments are not limited to the above-mentioned effects, and other effects not mentioned herein may be clearly derived and understood by a person skilled in the art based on the following detailed description.

### DESCRIPTION OF DRAWINGS

The accompanying drawings are provided to help understanding of the embodiment, along with a detailed description. However, the technical features of the embodiment are not limited to a specific drawing, and features disclosed in each drawing may be combined with each other to constitute a new embodiment. Reference numerals in each drawing denote structural elements.

FIG. 1 is a diagram illustrating physical channels and a signal transmission method using the physical channels, which may be used in the embodiment.

FIG. 2 is a diagram illustrating an example of a 6G communication structure to which an embodiment is applicable.

FIG. 3 is a diagram illustrating an example of an OAM antenna to which an embodiment is applicable.

FIG. 4 is a diagram illustrating an example of an OAM antenna to which an embodiment is applicable.

FIG. 5 is a diagram illustrating an example of a circular array structure to which an embodiment is applicable.

FIG. 6 is a diagram illustrating an example of an OAM having orthogonal beams to which an embodiment is applicable.

FIG. 7 is a diagram illustrating an example of an OAM having non-orthogonal beams to which an embodiment is applicable.

FIG. 8 is a diagram illustrating an example of angular momentum to which an embodiment is applicable.

FIG. 9 is a diagram illustrating an example of a signaling procedure between a UE and a BS according to an embodiment.

FIG. 10 is a diagram illustrating a method of operating a UE and a network node according to an embodiment.

FIG. 11 is a diagram illustrating a method of operating a UE and a network node according to an embodiment.

FIG. 12 is a flowchart illustrating a method of operating a UE according to an embodiment.

FIG. 13 is a flowchart illustrating a method of operating a network node according to an embodiment.

FIG. 14 is a diagram illustrating a device they may implement an embodiment.

FIG. 15 illustrates a communication system applied to an embodiment.

FIG. 16 illustrates exemplary wireless devices applied to an embodiment.

FIG. 17 illustrates other exemplary wireless devices applied to an embodiment.

FIG. 18 illustrates an exemplary portable device applied to an embodiment.

FIG. 19 illustrates an exemplary vehicle or autonomous driving vehicle applied to an embodiment.

### BEST MODE

The embodiment is applicable to a variety of wireless access technologies such as code division multiple access (CDMA), frequency division multiple access (FDMA), time division multiple access (TDMA), orthogonal frequency division multiple access (OFDMA), and single carrier frequency division multiple access (SC-FDMA). CDMA can be implemented as a radio technology such as Universal Terrestrial Radio Access (UTRA) or CDMA2000. TDMA can be implemented as a radio technology such as Global System for Mobile communications (GSM)/General Packet Radio Service (GPRS)/Enhanced Data Rates for GSM Evolution (EDGE). OFDMA can be implemented as a radio technology such as Institute of Electrical and Electronics Engineers (IEEE) 802.11 (Wireless Fidelity (Wi-Fi)), IEEE 802.16 (Worldwide interoperability for Microwave Access (WiMAX)), IEEE 802.20, and Evolved UTRA (E-UTRA). UTRA is a part of Universal Mobile Telecommunications System (UMTS). 3rd Generation Partnership Project (3GPP) Long Term Evolution (LTE) is part of Evolved UMTS (E-UMTS) using E-UTRA, and LTE-Advanced (A) is an evolved version of 3GPP LTE. 3GPP NR (New Radio or New Radio Access Technology) is an evolved version of 3GPP LTE/LTE-A.

The embodiment is described in the context of a 3GPP communication system (e.g., including LTE, NR, 6G, and next-generation wireless communication systems) for clarity of description, to which the technical spirit of the embodiment is not limited. For the background art, terms, and abbreviations used in the description of the embodiment, refer to the technical specifications published before the present disclosure. For example, the documents of 3GPP TS 36.211, 3GPP TS 36.212, 3GPP TS 36.213, 3GPP TS 36.300, 3GPP TS 36.321, 3GPP TS 36.331, 3GPP TS 36.355, 3GPP TS 36.455, 3GPP TS 37.355, 3GPP TS 37.455, 3GPP TS 38.211, 3GPP TS 38.212, 3GPP TS 38.213, 3GPP TS 38.214, 3GPP TS 38.215, 3GPP TS 38.300, 3GPP TS 38.321, 3GPP TS 38.331, 3GPP TS 38.355, 3GPP TS 38.455, and so on may be referred to.

### 3GPP System

### Physical Channels and Signal Transmission and Reception

In a wireless access system, a UE receives information from a base station on a downlink (DL) and transmits information to the base station on an uplink (UL). The information transmitted and received between the UE and the base station includes general data information and various types of control information. There are many physical channels according to the types/usages of information transmitted and received between the base station and the UE.

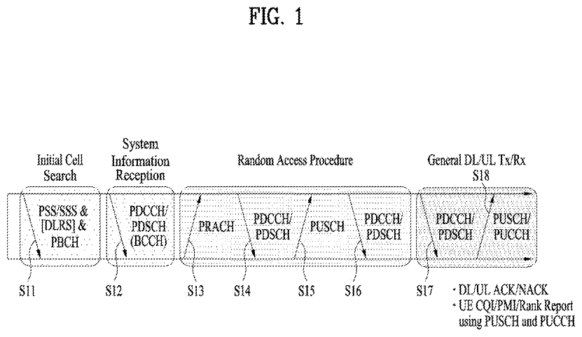

FIG. 1 is a diagram illustrating physical channels and a signal transmission method using the physical channels, which may be used in the embodiment.

When powered on or when a UE initially enters a cell, the UE performs initial cell search involving synchronization with a BS in step S11. For initial cell search, the UE receives a synchronization signal block (SSB). The SSB includes a primary synchronization signal (PSS), a secondary synchronization signal (SSS), and a physical broadcast channel (PBCH). The UE synchronizes with the BS and acquires information such as a cell Identifier (ID) based on the PSS/SSS. Then the UE may receive broadcast information from the cell on the PBCH. In the meantime, the UE may check a downlink channel status by receiving a downlink reference signal (DL RS) during initial cell search.

After initial cell search, the UE may acquire more specific system information by receiving a physical downlink control channel (PDCCH) and receiving a physical downlink shared channel (PDSCH) based on information of the PDCCH in step S12.

Subsequently, to complete connection to the eNB, the UE may perform a random access procedure with the eNB (S13 to S16). In the random access procedure, the UE may transmit a preamble on a physical random access channel (PRACH) (S13) and may receive a PDCCH and a random access response (RAR) for the preamble on a PDSCH associated with the PDCCH (S14). The UE may transmit a physical uplink shared channel (PUSCH) by using scheduling information in the RAR (S15), and perform a contention resolution procedure including reception of a PDCCH signal and a PDSCH signal corresponding to the PDCCH signal (S16).

Aside from the above 4-step random access procedure (4-step RACH procedure or type-1 random access procedure), when the random access procedure is performed in two steps (2-step RACH procedure or type-2 random access procedure), steps S13 and S15 may be performed as one UE transmission operation (e.g., an operation of transmitting message A (MsgA) including a PRACH preamble and/or a PUSCH), and steps S14 and S16 may be performed as one BS transmission operation (e.g., an operation of transmitting message B (MsgB) including an RAR and/or contention resolution information)

After the above procedure, the UE may receive a PDCCH and/or a PDSCH from the BS (S17) and transmit a PUSCH and/or a physical uplink control channel (PUCCH) to the BS (S18), in a general UL/DL signal transmission procedure.

Control information that the UE transmits to the BS is generically called uplink control information (UCI). The UCI includes a hybrid automatic repeat and request acknowledgement/negative acknowledgement (HARQ-ACK/NACK), a scheduling request (SR), a channel quality indicator (CQI), a precoding matrix index (PMI), a rank indicator (RI), etc.

In general, UCI is transmitted periodically on a PUCCH. However, if control information and traffic data should be transmitted simultaneously, the control information and traffic data may be transmitted on a PUSCH. In addition, the UCI may be transmitted aperiodically on the PUSCH, upon receipt of a request/command from a network.

### Physical Resource

The BS transmits related signals to the UE on DL channels as described below, and the UE receives the related signals from the BS on the DL channels.

The PDSCH conveys DL data (e.g., DL-shared channel transport block (DL-SCH TB)) and uses a modulation scheme such as quadrature phase shift keying (QPSK), 16-ary quadrature amplitude modulation (16 QAM), 64 QAM, or 256 QAM. A TB is encoded into a codeword. The PDSCH may deliver up to two codewords. Scrambling and modulation mapping are performed on a codeword basis, and modulation symbols generated from each codeword are mapped to one or more layers (layer mapping). Each layer together with a demodulation reference signal (DMRS) is mapped to resources, generated as an OFDM symbol signal, and transmitted through a corresponding antenna port.

The PDCCH may deliver downlink control information (DCI), for example, DL data scheduling information, UL data scheduling information, and so on. The PUCCH may deliver uplink control information (UCI), for example, an acknowledgement/negative acknowledgement (ACK/NACK) information for DL data, channel state information (CSI), a scheduling request (SR), and so on.

The PDCCH carries downlink control information (DCI) and is modulated in quadrature phase shift keying (QPSK). One PDCCH includes 1, 2, 4, 8, or 16 control channel elements (CCEs) according to an aggregation level (AL). One CCE includes 6 resource element groups (REGs). One REG is defined by one OFDM symbol by one (P) RB.

The PDCCH is transmitted in a control resource set (CORESET). A CORESET is defined as a set of REGs having a given numerology (e.g., SCS, CP length, and so on). A plurality of CORESETs for one UE may overlap with each other in the time/frequency domain. A

CORESET may be configured by system information (e.g., a master information block (MIB)) or by UE-specific higher layer (RRC) signaling. Specifically, the number of RBs and the number of symbols (up to 3 symbols) included in a CORESET may be configured by higher-layer signaling.

The UE acquires DCI delivered on a PDCCH by decoding (so-called blind decoding) a set of PDCCH candidates. A set of PDCCH candidates decoded by a UE are defined as a PDCCH search space set. A search space set may be a common search space (CSS) or a UE-specific search space (USS). The UE may acquire DCI by monitoring PDCCH candidates in one or more search space sets configured by an MIB or higher-layer signaling.

The UE transmits related signals on later-described UL channels to the BS, and the BS receives the related signals on the UL channels from the UE.

The PUSCH delivers UL data (e.g., a UL-shared channel transport block (UL-SCH TB)) and/or UCI, in cyclic prefix-orthogonal frequency division multiplexing (CP-OFDM) waveforms or discrete Fourier transform-spread-orthogonal division multiplexing (DFT-s-OFDM) waveforms. If the PUSCH is transmitted in DFT-s-OFDM waveforms, the UE transmits the PUSCH by applying transform precoding. For example, if transform precoding is impossible (e.g., transform precoding is disabled), the UE may transmit the PUSCH in CP-OFDM waveforms, and if transform precoding is possible (e.g., transform precoding is enabled), the UE may transmit the PUSCH in CP-OFDM waveforms or DFT-s-OFDM waveforms. The PUSCH transmission may be scheduled dynamically by a UL grant in DCI or semi-statically by higher-layer signaling (e.g., RRC signaling) (and/or layer 1 (L1) signaling (e.g., a PDCCH)) (a configured grant). The PUSCH transmission may be performed in a codebook-based or non-codebook-based manner.

The PUCCH delivers UCI, an HARQ-ACK, and/or an SR and is classified as a short PUCCH or a long PUCCH according to the transmission duration of the PUCCH.

### 6G System

A 6G (wireless communication) system to which one embodiment is applicable is aimed at (i) a very high data rate per device, (ii) a very large number of connected devices, (iii) global connectivity, (iv) a very low latency, (v) battery-free IoT devices, (vi) an ultra-reliable connection, (vii) connected intelligence having machine learning capability, etc. The vision of the 6G system may be in four aspects: intelligent connectivity, deep connectivity, holographic connectivity, and ubiquitous connectivity. The 6G system may satisfy requirements as shown in Table 1 below. That is, Table 1 shows an example of requirements of the 6G system.

TABLE 1

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | Up to 1000 km/hr |
| Satellite integration | Fully |
| AI | Fully |
| Autonomous vehicle | Fully |
| XR | Fully |
| Haptic Communication | Fully |

The 6G system to which one embodiment is applicable may have key factors such as enhanced mobile broadband (eMBB), ultra-reliable low latency communications (URLLC), massive machine-type communication (mMTC), AI integrated communication, tactile internet, high throughput, high network capacity, high energy efficiency, low backhaul and access network congestion, and enhanced data security.

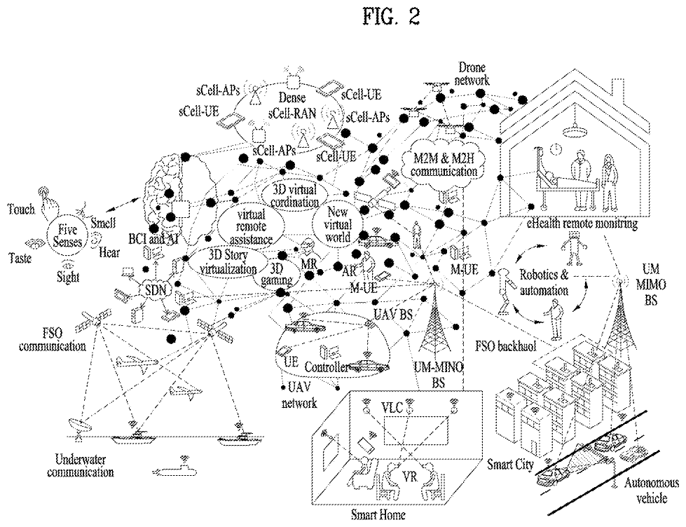

FIG. 2 is a diagram illustrating an example of a 6G communication structure to which an embodiment is applicable.

6G systems are expected to have 50 times higher concurrent wireless communication connectivity than 5G wireless communication systems. URLLC, a key feature of the 5G system, will become a more dominant technology in 6G communications by providing end-to-end delay of less than 1 ms. 6G systems may have much better volumetric spectrum efficiency, unlike the more commonly used area spectrum efficiency. 6G systems will be able to provide very long battery life and advanced battery technology for energy harvesting, and thus mobile devices will not need to be charged separately in a 6G system. New network characteristics in 6G may include the followings.
Satellites integrated network: 6G is expected to be integrated with the satellite to provide a global mobile population. Integration of terrestrial, satellite and public networks into one wireless communication system is very important for 6G.
Connected intelligence: Unlike previous generations of wireless communication systems, 6G is revolutionary and will update the wireless evolution from “connected things” to “connected intelligence”. AI can be applied in each step of the communication procedure (or each step of signal processing which will be discussed later).
Seamless integration wireless information and energy transfer: 6G wireless networks will transfer power to charge the batteries of devices such as smartphones and sensors. Therefore, wireless information and energy transfer (WIET) will be integrated.
Ubiquitous super 3D connectivity: Access to networks and core network functions of drones and very low Earth orbit satellites will make super 3D connection in 6G ubiquity.

In the above new network characteristics of 6G, some common requirements may include the followings.
Small cell networks: The idea of small cell networks was introduced in cellular systems to improve the received signal quality as a result of improved throughput, energy efficiency, and spectral efficiency. As a result, small cell networks are an essential characteristic for 5G and beyond 5G (5 GB) communication systems. Therefore, 6G communication systems will also adopt the characteristics of small cell networks.
Ultra-dense heterogeneous network: Ultra-dense heterogeneous networks will be another important characteristic of 6G communication systems. Multi-tier networks composed of heterogeneous networks will improve overall QoS and reduce costs.
High-capacity backhaul: A backhaul connection is characterized by high-capacity backhaul networks to support large volumes of traffic. High-speed fiber optics and free-space optics (FSO) systems may be possible solutions to this issue.
Radar technology integrated with mobile technology: High-precision localization (or location-based services) through communications is one of the functions of 6G wireless communication systems. Therefore, radar systems will be integrated with 6G networks.
Softwarization and virtualization: Softwarization and virtualization are two important functions are the basis of a design process in 5 GB networks to ensure flexibility, reconfigurability, and programmability. In addition, billions of devices may be shared on a shared physical infrastructure.

### One Embodiment

Hereinafter, an embodiment will be described in detail based on the above-described technical idea. The above-described details may be applied to embodiments described below. For example, operations, functions, terms, and the like which are not defined in in the embodiments described below may be performed and described based on the details described above.

In the description of one embodiment, the BS may be understood as a comprehensive term including a remote radio head (RRH), an eNB, a gNB, aTP, a reception point (RP), a relay, and the like.

In the description of one embodiment, the base station may be a station and/or a transmitter/receiver that is the subject of the network control and/or data and/or synchronization protocol of the network.

While the description of one embodiment is based on a frequency band with a channel rank of 1, this is for illustrative purposes only and does not limit the embodiment. Accordingly, the embodiment may also be applied based on a frequency band with a channel rank of 2 or higher.

In the description of one embodiment, the phrase “greater than/greater than or equal to A” may be replaced with “greater than or equal/greater than A.”

In the description of one embodiment, “less than/less than or equal B” may be replaced with “less than or equal/less than B.”

THz wireless communication is wireless communication using THz waves having a frequency of approximately 0.1 to 10 THz (1 THz=1012 Hz), and may refer to terahertz (THz) band wireless communication using very high carrier frequencies greater than or equal to 100 GHz.

THz waves are located between the radio frequency (RF)/millimeter (mm) an infrared band. They are transmitted through (i) non-metallic/non-polarized materials well compared to visible/infrared light, and have a shorter wavelength compared to RF/millimeter waves, which allows for high straightness and beam focusing. In addition, the photon energy of THz waves is only several meV, and thus it is harmless to the human body.

The frequency band expected to be used for THz wireless communication may be the D-band (110 GHz to 170 GHz) or H-band (220 GHz to 325 GHZ), in which the propagation loss due to absorption by molecules in the air is small. Standardization of THz wireless communications is being discussed in the IEEE 802.15 THz working group in addition to 3GPP, and standard documents issued by the IEEE 802.15 task groups (TG3d, TG3e) may embody or supplement the contents described herein.

THz wireless communications may be applied to wireless cognition, sensing, imaging, wireless communication, THz navigation, and the like.

THz wireless communication scenarios may be categorized into macro networks, micro networks, and nanoscale networks. In macro networks, THz wireless communication may be applied to a vehicle-to-vehicle connection and backhaul/fronthaul connection. In micro networks, THz wireless communication may be applied to indoor small cells, fixed point-to-point or multi-point connections such as wireless connections in a data center, and near-field communication such as kiosk downloading.

In beyond 5G communications, scenarios are emerging to utilize ultra-wideband in the THz band, including the existing spectrum (under 6 GHz, mmWave, etc.). A typical THz band represents 100 GHz to 10 THz, but 100 GHz to 300 GHz is being considered as an early THz region. The THz band is different from the existing under 100 GHz band channels in that the number of existing multipaths is significantly reduced (1 to 3 clusters). Therefore, it is likely to be utilized in communication scenarios with very low mobility in line of sight environments or environments utilizing one or two reflectors.

Orbital Angular Momentum (OAM) is a method capable of replacing the maximum 2 multiplexing of H/V (horizontal/vertical) polarization. Depending on the antenna array application, OAM may utilize N multiplexing, which may increase the communication capacity. For example, the multiplexing gain may be maximized by simultaneously transmitting beams with sufficient orthogonality among the beams using OAM, and reception may be performed according to the OAM state on the receiving side.

According to one embodiment, considering the communication environment of the THz band (e.g., 100 GHz to 10 THz), scrambling seeds applicable to orthogonal sequence design, which may reduce overhead in beam pairing and/or OAM pairing due to the overhead limits of existing CSI reporting and resource indication and achieve reduction in beam management procedures in beam management between an orbital angular momentum (OAM)-based transmission and reception point (TRP) (or personal basic service point (PCP) terminal) and another UE capable or incapable of OAM transmission and OAM detection (or non-personal basic service point (NPCP) terminal) (in the description of one embodiment, beam management includes not only Tx/Rx beam pairing and Tx/Rx OAM state pairing from an array perspective), may be provided along with utilization methods

One embodiment will be described in detail below. The embodiments described herein may be combined in whole or in part to form another embodiment, provided that they are not mutually exclusive, as will be apparent to those skilled in the art.

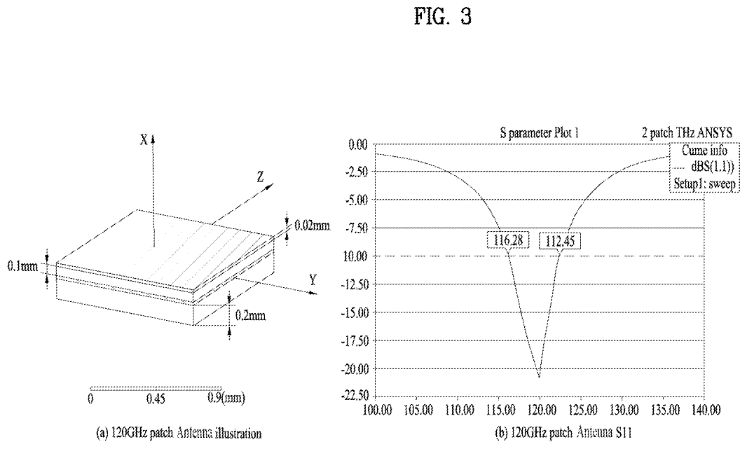

FIG. 3 is a diagram illustrating an example of an OAM antenna to which an embodiment is applicable.

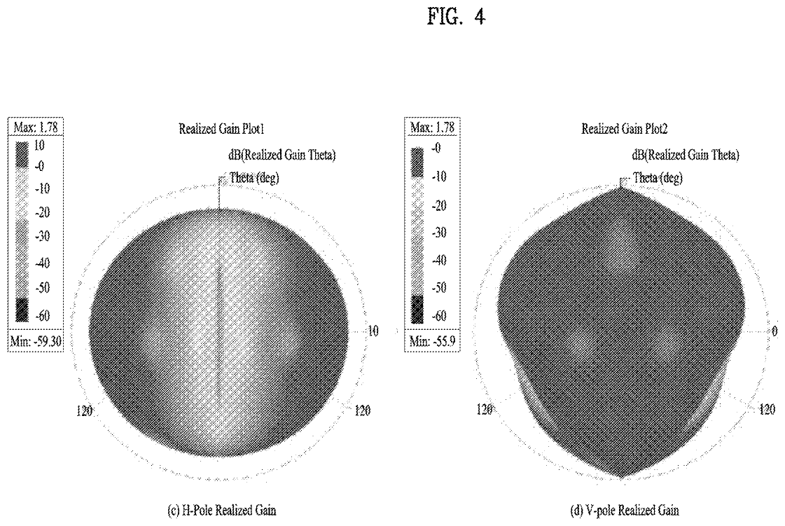

FIG. 4 is a diagram illustrating an example of an OAM antenna to which an embodiment is applicable.

The 120 GHz patch antenna shown in FIG. 3-(a) is merely an example of a patch antenna structure to which one embodiment is applicable, and embodiments are not limited thereto.

Referring to FIGS. 3-(b) to 4-(d), the performance of a single antenna (120 GHz single patch antenna/v-pole antenna) applicable to one embodiment shows a peal realized gain of 3.4 dBi and a peak V-pole to H-pole realized gain ratio of 1.98 dB.

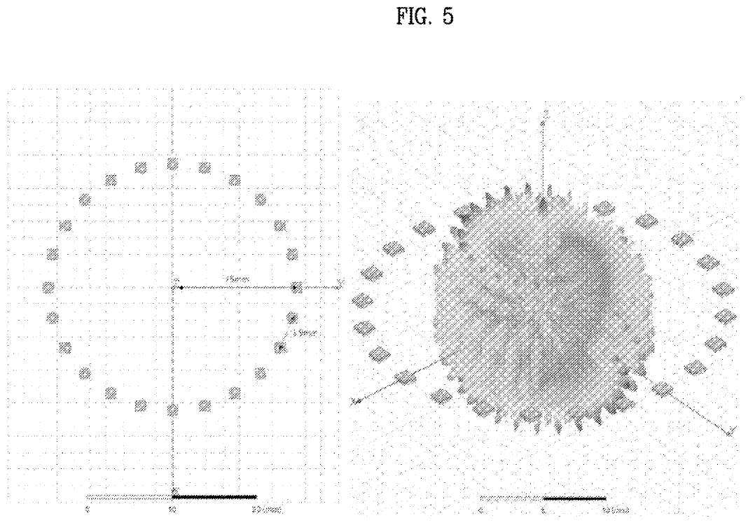

FIG. 5 is a diagram illustrating an example of a circular array structure to which an embodiment is applicable.

The 1-tier ring 1×24 120 GHz patch array shown in FIG. 5 is merely an example of a circular array structure to which one embodiment is applicable, and embodiments are not limited thereto.

Referring to FIG. 5, a 1×24 circular array to which an embodiment is applicable may be designed to fix the spin angular momentum (SAM) (to improve the accuracy of OAM state estimation) (s=−1, wherein s is spin angular acceleration).

For the antenna array of FIG. 5 to which one embodiment is applicable, the number of OAM states may not exceed 12 according to the maximum number of OAM states. To satisfy the condition D<<R, a distance D between the antenna elements may be set to 3.9 mm and a distance R from the coordinate center to the array may be set to 15 mm. An OAM state may be represented by applying a phase of

$${exp}^{jlk \times \frac{2 π \times 24}{360}}$$

to the k-th single antenna of the ring array 1×24.

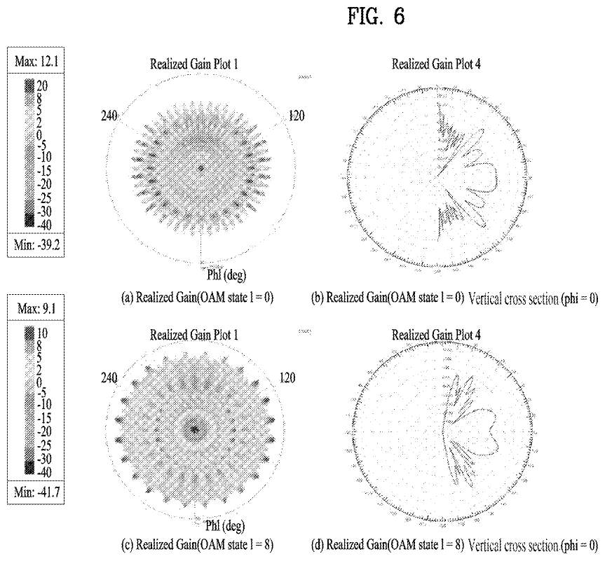

FIG. 6 is a diagram illustrating an example of an OAM having orthogonal beams to which an embodiment is applicable. In FIG. 6, the orthogonal OAM states are 1=0 and 1=8.

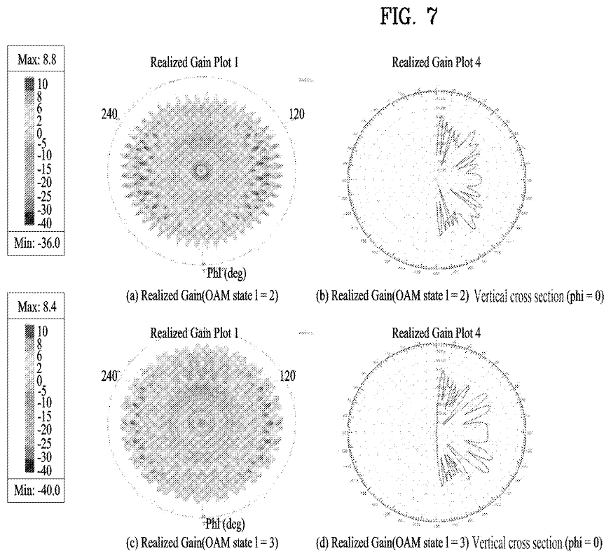

FIG. 7 is a diagram illustrating an example of an OAM having non-orthogonal beams to which an embodiment is applicable. In FIG. 7, the non-orthogonal OAM states are 1=0 and 1-8.

Referring to FIGS. 6 and 7, some of the beams corresponding to the maximum OAM state may be orthogonal or non-orthogonal. Therefore, the orthogonal OAM states for actually increasing the number of streams may be M states out of the total N OAM states (N>=M). Therefore, antenna designs for OAMs approaching N may be required.

In the example of applying OAM to a cellular system, the orthogonal OAM state may change all the time depending on the channel conditions. Therefore, a method of applying an orthogonal OAM state in response to channel changes may be needed.

In addition, it may be necessary to consider whether the UE is capable of receiving OAM regarding the OAM capability of the BS. The UE may need to have at least capability greater than or equal to the OAM capability y of the BS, and/or the BS OAM capability may be maintained based on the UE with the lowest OAM capability among the connected UEs. In addition to this, it may also be considered Furthermore, methods for applying OAM to UEs other than those that do not meet any OAM capability criterion may also be considered.

In the existing NR codebook (Type-1), a method utilizing V/H polarization through a co-phase factor according to the channel rank during digital beamforming has been introduced. In other words, by multiplying the codebook by the same co-phase for the same beam, polarization may be represented, and the number of streams may be increased.

On the other hand, in increasing the number of streams through OAM, it is not allowed to represent the OAM state with a co-phase. An incremental or decremental phase may need to be applied to each logical port.

The above issues may be summarized as follows.
Designing antennas suitable for OAM operation (antennas with M orthogonal OAM states among N OAM states)
Basic configuration for OAM operation
Network operation according to OAM operation capability (e.g., issues raised by asymmetry of transmit and receive OAM states, and the like)
Codebook for applying OAM
Feedback method and application method for OAM
Need to check whether beamforming is possible when applying OAM or whether OAM is possible after applying beamforming

According to one embodiment, an effective procedure for configuration of available scrambling seeds for generating sequences applicable to beam management and utilizing the same for beam management may be provided, given Tx/Rx beamforming pairing and Tx/Rx OAM state pairing.

According to one embodiment, the Tx/Rx beam and OAM state indications and associated CSI reporting used for Tx/Rx beamforming pairing and Tx/Rx OAM state pairing may incur excessive overhead. The overhead for Tx/Rx beam and OAM state indications and CSI reporting may be reduced by utilizing scrambling seed information.

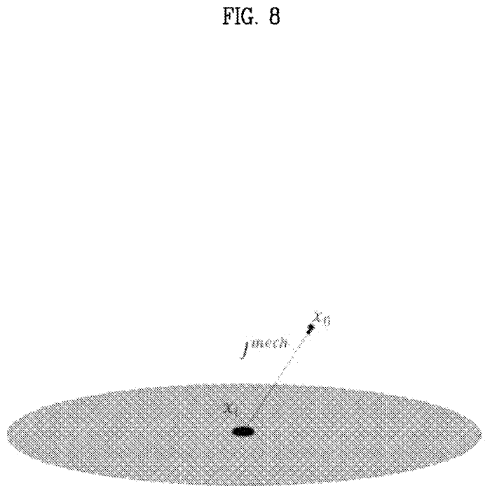

FIG. 8 is a diagram illustrating an example of angular momentum to which an embodiment is applicable.

Electromagnetic radiation may transfer both energy and momentum. Momentum is a physical quantity that describes the motion of a particle by radio waves, and may be a physical quantity for particles moving linearly and angularly.

The linear momentum Pᵢ^{mech} of a nonrelativistic, spinless, classical particle may have angular momentum. The angular momentum (linear) J^{mech} with respect to the radiation point xi may be given by the following equation.

$${J}^{mech} = {\sum }_{i} ( {x}_{i} - {x}_{0} ) \times {P}_{i}^{mech}$$

Referring to FIG. 8, the angular momentum of a point x₀ with respect to the radiation point (radiation source) may be given by the following equation.

The total angular momentum may be given by the following equation.

$${J}^{tot} = {J}^{mech} + {J}^{EM}$$

J^{EM} may be the sum of the spin angular momentum (SAM) S^{EM} and the OAM L^{EM}

$${J}^{EM} = {S}^{EM} + {L}^{EM} = \int ( x - {x}_{0} ) \times ( E \times B ) {d}^{3} x$$

Depending on the OAM state (or OAM mode), the orthogonal beam and energy field distribution (or the shape of the beam) may vary.

For example, an OAM state may have an OAM component of

$${J}_{z}^{EM} = \frac{jM}{w}$$

with respect to the beam direction (e.g., z direction). For example, the OAM state may be affected by a vertical phase of e^{jlφ} (H=field energy, w=frequency).

To verify the applicability of OAM, equally spaced circular array antennas (with strong right-hand circular polarization) are considered. J^{EM}_{z} (this factor is estimated on the receiving side based on the transmit/receive distance x0 and the values of the E and H fields and/or the poynting vector) may be predicted. On the other hand, if the received energy M is measurable, the OAM state \hat{1} (the estimated value of the OAM state) may be estimated (right-hand: s=−1, left-hand: s=1).

An example of a comparison between the estimated OAM state \hat{1} and the actual OAM state 1 may be shown in Table 2 (a right-hand circular polarized beam (s=−1) formed by a ring array of 10 crossed dipoles, inter-array spacing D=2, 0.12 over perfect ground, polar angle 0=0). It may be seen from Table 2 that the OAM state may be estimated by measuring the received energy, etc.

TABLE 2

| l | s | j = l + s | $\hat{J} = \frac{w \cdot {J}_{z}^{EM}}{M}$ | \hat{l} |
|---|---|---|---|---|
| 0 | −1 | −1 | −1.019 | −0.019 |
| 1 | −1 | 0 | −0.022 | 0.978 |
| 2 | −1 | 1 | 0.971 | 1.971 |
| 3 | −1 | 2 | 1.81 | 2.81 |

Basically, the total number of generatable OA states, N, may be equal to the number of antennas/2 on the ring perpendicular to the beam direction (For the case of a ‘-tier ring array, see FIG. 5). The number of estimable OAM states may have the following mathematical relationship.

$$\vert \hat{l} \vert < Total number of antenna elements \times \frac{π R}{D}$$

Therefore, the condition R>>D may need to be satisfied for an OAM transmission that obtains the maximum number of estimable OAM states (where R=distance from the center to the array, and D-distance between two adjacent antenna elements).

### Proposal 1

According to one embodiment, an OAM state and/or an OAM orthogonal state may be applied as a scrambling seed value for generating an orthogonal sequence and/or as a value that serves as a base for the orthogonal sequence.

According to one embodiment, depending on the application, the scrambling seed value and/or the base value of the orthogonal sequence may include a number of M bits relative to a total number of bits N (N>=M). According to one embodiment, these values may explicitly and/or implicitly specify the OAM orthogonal state and/or OAM transmission.

According to one embodiment, an indication of whether to use the OAM orthogonal state information as a scrambling seed and/or base value for sequence generation may be provided in a higher layer (e.g., radio access control (RRC), medium access control-control element (MAC-CE)), and/or DCI.

According to one embodiment, when the scrambling seed value is applied for the data channel, the scrambling seed value may be applied for the pseudo-random sequence Cint as follows.

$${c}_{init} = {n}_{RNTI} \cdot {2}^{N 1 + N 3} + {n}_{OAM} \cdot {2}^{N 1} + {n}_{ID}$$

n_{RNTI}: The value of the RNTI related to the data channel transmission. For example, it may be the value corresponding to the RNTI related to PUSCH transmission, the value corresponding to the RNTI related to PDSCH transmission, or the value corresponding to the RA-RNTI for message A. It may be configured for cyclic redundancy check (CRC).

n_{OAM}: OAM state and/or OAM orthogonal state

n_{ID}: may be set by a higher layer and/or may be a cell ID and/or a PCP unique ID.

According to one embodiment, the total number of Cint bits, K, may consist of N1 bits for the cell ID and/or unique PDP ID that is the subject of the transmission, N2 bits for parity check of the data channel, and/or N3 bits for OAM state information and exclusive/implicit information, where K=N1+N2+N3.

For example, considering the 31-length gold sequence used in NR, Cint may be represented as follows.

$${c}_{init} = \cdot {2}^{15} + {n}_{OAM} \cdot {2}^{11} + {n}_{ID}$$

For example, n_{ID} denotes the number of bits for the cell ID or PCP unique ID and may have 11 bits, n_{OAM} denotes the OAM state information and may have 4 bits in total, and n_{RNTI} may have 16 bits for the CRC. Thus, Cinit may consist of 31 bits in total.

In one embodiment, the positions of the bits for the above information may be changed.

According to one embodiment, for a zadoff chu (ZC) sequence used for low-PAPR (Peak-to-Average Power Ratio), OAM state information may be taken into account and applied to the group number u and/or base sequence number v.

$${u}_{new} = {n}_{OAM} \cdot {2}^{N 1} + {u}_{Origin}$$

For example, when the ZC sequence length, i.e., 6 RBs or more (i.e., 72 length or more) are secured for transmission, namely, when the prime number Nzc for generating the ZC sequence is set to 61, 60 types are possible for representations for the group number u_{new}, and 15 (4 bits) of 30 existing group numbers u may be used and/or additionally available n_{OAM} may be represented by 4 (2 bits) types of the OAM state information.

In other words, for example, when u_{new} is represented as a binary number, it may be given as follows.

$${u}_{new} = {n}_{OAM} \cdot {2}^{5} + {u}_{Origin}$$

In the example above, for u_{Origin}, up to 4 bits out of the 30 existing group numbers (5 bits) are used. For n_{OAM}, the OAM state index value of 2 bits is considered.

As another example, when the prime number Nzc is set to 127, the total number of group numbers is 30, and 126 types, that is 7 bits may be considered as u_{new}. u_{Origin} may select any of the 30 group numbers, and the remaining 2 bits may be used as n_{OAM}. That is, it may be given as follows.

$${u}_{new} = {n}_{OAM} \cdot {2}^{6} + {u}_{Origin}$$

Additionally/alternatively, the group numbers u_{Origin} and n_{OAM} may be dichotomized.

$${u}_{new} = \{ \begin{matrix}{n}_{OAM} , most significant bit = 0 \\ {u}_{Origin} , most significant bit = 1\end{matrix}$$

That is, when the most significant bit (MSB) of u_{new} is 0, u_{new} may be considered to be n_{OAM}. When the MSB is 1, u_{new} may be considered to be u_{Origin}. The values of the MSB may be reversed.

According to one embodiment, when the scrambling seed value of the orthogonal sequence for beam management is considered, the N1 bits indicating an OAM state and the N2 bits indicating which transmission and reception point (TRP) and/or PCP has performed transmission, and an orthogonal sequence may be generated. In one embodiment, for OAM transmission, the N3 bit for the layer index may be basically added to support the ability to transmit different OAM states for different layers. That is, N1+N2+N3=Cinit bit number K.

$${c}_{init} = {n}_{L} \cdot {2}^{N 1 + N 2} + {n}_{OAM} \cdot {2}^{N 2} + {n}_{ID}$$

For example, a 4-layer transmission may consist of layers L={0, 1,2,3}. When the OAM state is to be applied, an equation may be configured based on the 31-length gold sequence applied in the NR. That is, it may be given as follows.

$${c}_{init} = {n}_{L} \cdot {2}^{21} + {n}_{OAM} \cdot {2}^{11} + {n}_{ID} ,$$

where n_{L} may be the layer index to be transmitted.

For example, based on the last bit, 2 bits representing the layer index and the remaining 8 bits may be presented as 0.

n_{OAM} may be OAM state information, which may be represented in 4 bits.

n_{ID} may be a cell ID and/or PCP ID, etc. consisting of 11 bits. Here, when resources for beam management are deployed on an RE-by-RE basis with respect to a certain fixed point (e.g., channel state information-reference signal (CSI-RS) deployment), the deployed RE indexes and/or symbol indexes may be included in the considered scrambling seed.

### Proposal 2

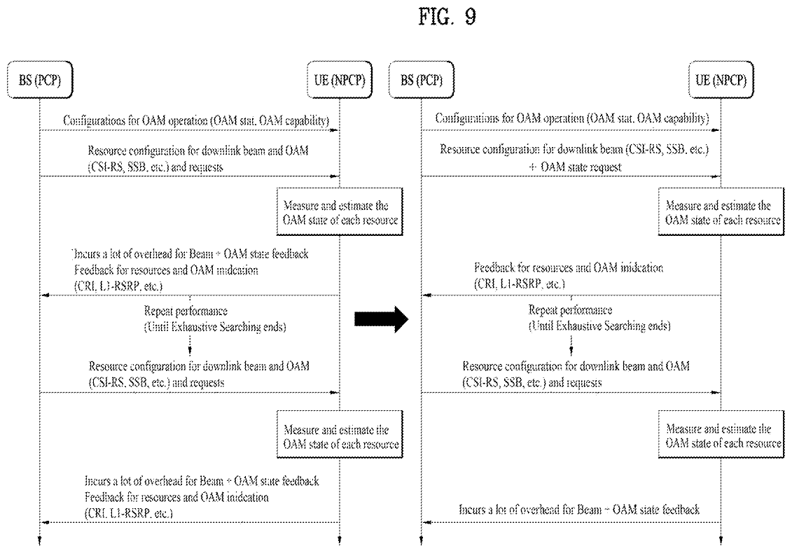

FIG. 9 is a diagram illustrating an example of a signaling procedure between a UE and a BS according to an embodiment. FIG. 9 illustrates an example of beam management signaling for beam+OAM in an NR-based system.

Referring to FIG. 9, in one embodiment, the UL feedback for OAM information may be replaced by utilizing the scrambling seed and/or base values for orthogonal sequence generation, and the signaling of FIG. 9 may be considered.

The diagram on the left side of FIG. 9 (based on the arrow) is for comparison with one embodiment.

The BS may transmit a configuration for the OAM operation and the UE may receive the same. For example, the configuration for the OAM operation may include one or more of an OAM state or OAM capability.

The BS may transmit, and the UE may receive, a resource configuration for a DL beam and/or OAM and/or a request for the same. For example, CSI-RS, SSB, and the like may be utilized.

The UE may measure and/or estimate the OAM state of each resource.

The UE may transmit feedback for resources and OAM indications, and the BS may receive the same. For example, the CSI-RS resource indicator (CRI) and/or layer1 reference signal received power (L1-RSRP) may be used. This operation may be performed repeatedly until exhaustive searching is completed. In this case, for example, a lot of overhead for beam and/or OAM state feedback may be incurred.

The BS may request, and the UE may receive, a resource configuration for the DL beam and OAM. For example, CSI-RS, SSB, or the like may be used.

The UE may measure and/or estimate the OAM state of each resource.

The UE may transmit feedback for resources and/or OAM indication. For example, CRI, L1-RSRP, or the like may be used. For example, in this cases, a large overhead for beam and/or OAM state feedback may be incurred.

The diagram on the right side of FIG. 9 (based on the arrow) illustrates an example of a signaling process according to one embodiment.

According to one embodiment, the BS may transmit a configuration for the OAM operation and the UE may receive the same. For example, the configuration for the OAM operation may include one or more of an OAM state or OAM capability.

According to one embodiment, the BS may transmit, and the UE may receive, a resource configuration for a DL beam and/or OAM and/or a request for the same. For example, CSI-RS, SSB, and the like may be utilized.

According to one embodiment, the UE may measure and/or estimate the OAM state of each resource.

According to one embodiment, the UE may transmit feedback for resources and OAM indications, and the BS may receive the same. For example, the CRI and/or L1-RSRP may be used. According to one embodiment, the feedback may include OAM feedback. This operation may be performed repeatedly until exhaustive searching is completed.

According to one embodiment, the BS may transmit, and the UE may receive, a request for a resource configuration (e.g., CSI-RS, SSB, etc.) and OAM state for the DL beam.

According to one embodiment, the UE may measure and/or estimate the OAM state of each resource.

According to one embodiment, the UE may transmit feedback for resources and/or OAM indication. For example, CRI, L1-RSRP, or the like may be used. According to one embodiment, the feedback may include OAM feedback.

When a TRP (PCP)/UE (NPCP) DL and/or forward link and/or UL and/or reverse link for analog beamforming is present in a wireless system with OAM transmission applied, let K1 be the number of beams required for beam management for analog beamforming without conventional OAM transmission, and let K2 be the number of OAM orthogonal states in an OAM wireless system. In this case, the total number of beams for beam management may be K1×K2 based on a DL single layer.

In terms of UL/DL Tx/Rx pairs based on the single layer, the beam management phase may be needed for an exhaustive search of K1×K2×R1×R2. Here, it is assumed that R1 is the total number of upward beams of the UE and R2 is the number of upward OAM states of the UE.

That is, in FIG. 9, resources for beams and resources for OAM states may need to be configured together, and may be accompanied by corresponding indications for the beams and/or OAM. Resource allocation for the beams and/or OAM within limited resources may result in additional resource allocation and, if performed on the basis of the existing beam indication and/or CSI reporting for beam management, may result in significant feedback overhead.

In one embodiment, the OAM feedback may utilize the reference signal (e.g., SRS) as the orthogonal sequence, and/or may utilize scrambling of UL reference signals. As an example of applying scrambling of the UL reference signals, the OAM state may be utilized as a scrambling seed as shown below for a corresponding orthogonal sequence in the SRS.

$${c}_{init} = {n}_{OAM} \cdot {2}^{11} + {n}_{ID}$$

According to one embodiment, by decoding the SRS, the BS may reverse compute the scrambling seed for the SRS for the following reasons. The BS may estimate n_{OAM} and recognize the OAM state of the corresponding Rx in terms of reciprocity, and recognize the information about the seed because ny is the BS ID

According to one embodiment, since the OAM state information about Tx of the BS is contained in the SRS, the OAM state of the Tx of the BS may be checked once again. In addition, by measuring the same, the L1-RSRP value for the OAM state may be derived (assuming OAM reciprocity is established). One condition that must be satisfied is that the BS should make a request to the UE for transmission of an SRS for the desired OAM state, and the OAM information requested by the BS should be specified in the scrambling seed when the SRS is transmitted, and the BS should maintain the OAM state as the Rx at the time when the SRS is decoded. Then, by comparing the back-calculated scrambling seed value with the currently set OAM state value (using reciprocity, wherein the Tx OAM state and the Rx OAM state are the same), the BS may check the L1-RSRP for the desired OAM state from the perspective of beam reciprocity.

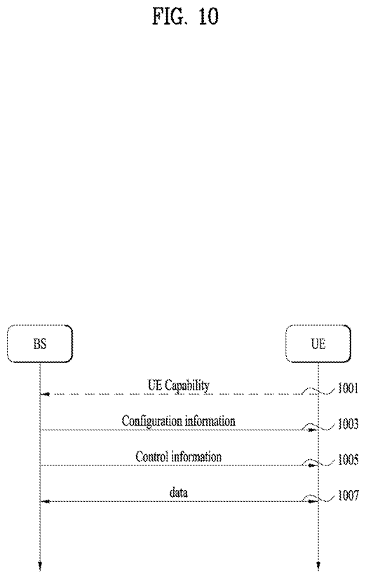

FIG. 10 is a diagram illustrating a method of operating a UE and a network node according to an embodiment.

An example of signaling between a BS and a UE for the above-described proposed methods (e.g., Proposal 1, Proposal 2, etc.) may be configured as shown in FIG. 10. FIG. 10 is for illustrative purposes only and is not intended to limit the scope of the embodiments. The BS may refer to an object that performs data transmission and reception with the UE. For example, the BS may include one or more transmission points (TPs) and one or more transmission and reception points (TRPs) (wherein the UE/BS is merely an example and may be replaced with various other devices as described below). Further, the TPs and/or TRPs may include BS panels and transmission and reception units. Further, some of the steps described in FIG. 10 may be combined or omitted.

According to one embodiment, a user equipment (UE) may transmit UE capability information to a base station (BS) (1301).

For example, the UE capability information may include information about whether the UE is capable of performing the methods described in the proposed methods (e.g., Proposal 1, Proposal 2, etc.) described above (e.g., transmission mode information supported by the UE). If the UE performance information is predefined/predetermined, this step may be omitted.

According to one embodiment, the UE may receive configuration information from the BS (1303).

For example, the configuration information may include system information (SI), and/or scheduling information, and/or CSI-related settings (e.g., CSI reporting setting/CSI-RS resource setting, etc.), and/or PUCCH/PUSCH-Config (e.g., TS 38.331 PUCCH/PUSCH Config), and/or PDCCH/PDSCH-Config (e.g., TS 38.331 PDCCH/PDSCH Config). For example, the configuration information may be received through a higher layer (e.g., RRC/MAC-CE).

The CSI-related settings may include at least one of CSI interference management (CSI-IM) resource related information, CSI measurement configuration related information, CSI resource configuration related information, CSI-RS resource related information, or CSI report configuration related information.

i) CSI-IM resource related information may include CSI-IM resource information and CSI-IM resource set information. A CSI-IM resource set is identified by a CSI-IM resource set identifier (ID), wherein a resource set includes at least one CSI-IM resource. Each CSI-IM resource is identified by the CSI-IM resource ID.

ii) CSI resource configuration related information may be represented by a CSI-ResourceConfig IE. The CSI resource configuration related information defines a group that includes at least one of a non zero power (NZP) CSI-RS resource set, a CSI-IM resource set, or a CSI-SSB resource set. That is, the CSI resource configuration related information may include a CSI-RS resource set list, wherein the CSI-RS resource set list may include at least one of a NZP CSI-RS resource set list, a CSI-IM resource set list, or a CSI-SSB resource set list. A CSI-RS resource set is identified by a CSI-RS resource set ID, wherein a resource set includes at least one CSI-RS resource. Each CSI-RS resource is identified by a CSI-RS resource ID.

As shown in Table 3, parameters indicating the purpose of the CSI-RS (e.g., a ‘repetition’ parameter related to BM, a ‘trs-Info’ parameter related to tracking) may be configured for each NZP CSI-RS resource set.

Table 3 shows an example of the NZP CSI-RS resource set IE.

```
TABLE 3
  ASN1START
  TAG-NZP-CSI-RS-RESOURCESET-START
```

| | |
|---|---|
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE (1..maxNrofNZP-CSI- |

RS-ResourcesPerSet)) OF NZP-CSI-RS-ResourceId,

| | |
|---|---|
| repetition | ENUMERATED { on, off } |
| | OPTIONAL, |
| aperiodicTriggeringOffset | INTEGER(0..4) |
| | OPTIONAL, -- Need S |
| trs-Info | ENUMERATED {true} |
| | OPTIONAL, -- Need R |

```
  ...
  }
  TAG-NZP-CSI-RS-RESOURCESET-STOP
  -- ASN1STOP
```

The repetition parameter corresponding to the higher layer parameter corresponds to the ‘CSI-RS-ResourceRep’ of the L1 parameter.

iii) The CSI report configuration related information includes a reportConfigType parameter indicating the time domain behavior and a reportQuantity parameter indicating the CSI related quantity for reporting. The time domain behavior may be periodic, aperiodic, or semi-persistent.

The CSI report configuration related information may be represented by a CSI-ReportConfig IE, and Table 4 below shows an example of the CSI-ReportConfig IE.

```
TABLE 4
    ASN1START
    TAG-CSI-RESOURCECONFIG-START
```

| | |
|---|---|
| CSI-ReportConfig ::= | SEQUENCE { |
| reportConfigId | CSI-ReportConfigId, |
| carrier | ServCellIndex |

OPTIONAL, -- Need S

| | |
|---|---|
| resourcesForChannelMeasurement | CSI-ResourceConfigId, |
| csi-IM-ResourcesForInterference | CSI-ResourceConfigId OPTIONAL, |

-- Need R

| | |
|---|---|
| nzp-CSI-RS-ResourcesForInterference | CSI-ResourceConfigId |

OPTIONAL, -- Need R

| | |
|---|---|
| reportConfigType | CHOICE { |
| periodic | SEQUENCE { |
| reportSlotConfig | CSI-ReportPeriodicityAndOffset, |
| pucch-CSI-ResourceList | SEQUENCE (SIZE (1..maxNrofBWPs)) |

OF PUCCH-CSI-Resource
},

| | |
|---|---|
| semiPersistentOnPUCCH | SEQUENCE { |
| reportSlotConfig | CSI-ReportPeriodicityAndOffset, |
| pucch-CSI-ResourceList | SEQUENCE (SIZE (1..maxNrofBWPs)) |

OF PUCCH-CSI-Resource
},

| | |
|---|---|
| semiPersistentOnPUSCH | SEQUENCE { |
| reportSlotConfig | ENUMERATED {sl5, sl10, sl20, sl40, sl80, |

sl160, sl320},

| | |
|---|---|
| reportSlotOffsetList | SEQUENCE (SIZE (1.. maxNrofUL- |

Allocations)) OF INTEGER(0..32),

| | |
|---|---|
| p0alpha | P0-PUSCH-AlphaSetId |

},

| | |
|---|---|
| aperiodic | SEQUENCE { |
| reportSlotOffsetList | SEQUENCE (SIZE (1..maxNrofUL- |

```
Allocations)) OF INTEGER(0..32)
    }
    },
```

| | |
|---|---|
| reportQuantity | CHOICE { |
| none | NULL, |
| cri-RI-PMI-CQI | NULL, |
| cri-RI-i1 | NULL, |
| cri-RI-i1-CQI | SEQUENCE { |
| pdsch-BundleSizeForCSI | ENUMERATED {n2, n4} |

```
  OPTIONAL
    },
```

| | |
|---|---|
| cri-RI-CQI | NULL, |
| cri-RSRP | NULL, |
| ssb-Index-RSRP | NULL, |
| cri-RI-LI-PMI-CQI | NULL |

},

For example, as described in the proposed methods above (e.g., Proposal 1, Proposal 2, etc.), the configuration information may include information related to the OAM state of the BS. For example, the OAM state related information may include a total number of OAM states of the BS, a maximum number of orthogonal OAM states, a set of OAM states, a subset of OAM states, information related to ring arrays of the BS (e.g., the number of ring arrays, the number of ring array ports), and transmission mode related information.

According to one embodiment, the UE may receive control information from the BS (1305). For example, the control information may be received on a control channel (e.g., PDCCH). As an example, the control information may be DCI. For example, the OAM state related information described above may be configured through the DCI.

According to one embodiment, the UE may transmit and receive data to and from the BS (1307). For example, when the data is DL data, it may be received from the BS on a DL channel (e.g., PDCCH/PDSCH). For example, when the data is UL data, it may be transmitted to the BS on a UL channel (e.g., PUCCH/PUSCH). For example, the data may be scheduled based on the configuration information/control information received in steps 1303/1305.

For example, the data may include information described in the proposed methods described above (e.g., proposal 1/proposal 2, etc.). For example, the data may include at least one of a number of OAM states configured for the UE, a number of OAM states detectable by the UE, an OAM subset, an OAM set, or an OAM state index. For example, the data may include feedback information about the TM settings of the BS from of the UE.

For example, the UE may receive a CSI-related RS (e.g., CSI-RS) from the BS, measure the same, and report the CSI to the BS. In this case, the data may include CSI report. For example, the CSI report may include a precoding matrix indicator (PMI), and a rank indicator (RI), wherein the PMI may be calculated based on the codebook described in Proposal 2 above.

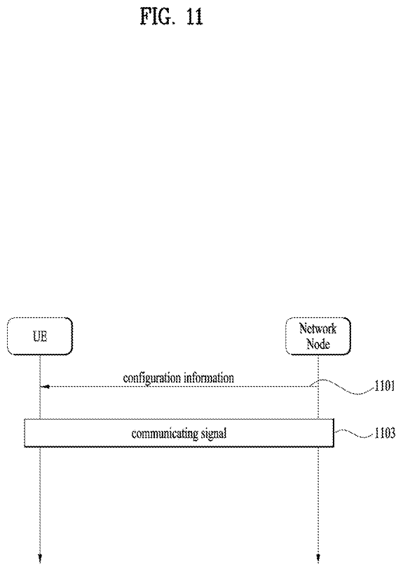

FIG. 11 is a diagram illustrating a method of operating a UE and a network node according to an embodiment.

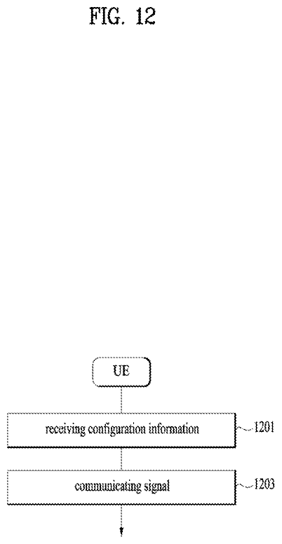

FIG. 12 is a flowchart illustrating a method of operating a UE according to an embodiment.

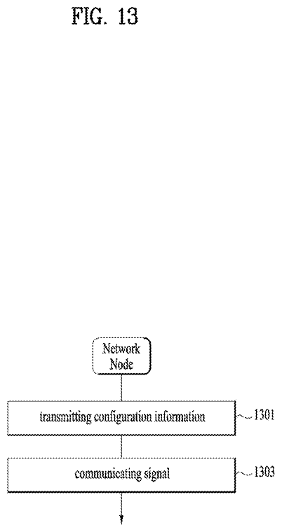

FIG. 13 is a flowchart illustrating a method of operating a network node according to an embodiment. For example, a network node may be a TP, and/or a BS, and/or a cell, and/or another UE, and/or any other device that performs the same operation.

Referring to FIGS. 11 to 13, in operations 1401, 1501, and 1601 according to one embodiment, the network node may transmit configuration information, and the UE may receive the same.

In operations 1403, 1503, and 1603 according to one embodiment, a signal may be communicated between the UE and the network node.

According to one embodiment, the signal may be communicated based on orbital angular momentum (OAM) based communication.

According to an embodiment, a sequence generator related to the generation of the signals may be initialized based on an OAM state of the OAM-based communication.

Specific operations of the UE and/or the network node according to the above-described the embodiment may be described and performed based on described before.

Since examples of the above-described proposal method may also be included in one of implementation methods of the embodiment, it is obvious that the examples are regarded as a sort of proposed methods. Although the above-proposed methods may be independently implemented, the proposed methods may be implemented in a combined (aggregated) form of a part of the proposed methods. A rule may be defined such that the BS informs the UE of information as to whether the proposed methods are applied (or information about rules of the proposed methods) through a predefined signal (e.g., a physical layer signal or a higher-layer signal).

### 4. Exemplary Configurations of Devices Implementing An Embodiment

4.1. Exemplary Configurations of Devices to which the Embodiment is Applied

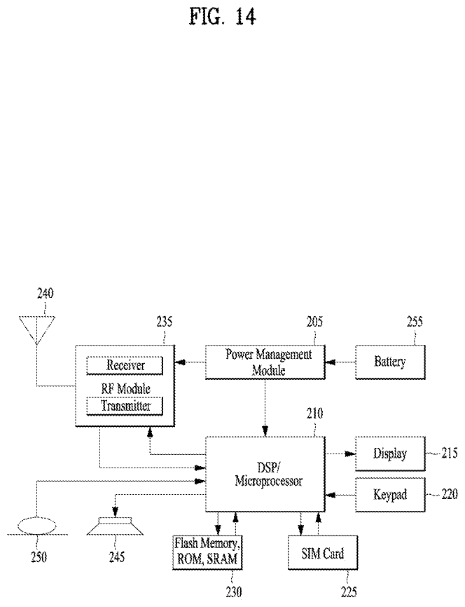

FIG. 14 is a diagram illustrating a device that may implement an embodiment.

The device illustrated in FIG. 14 may be a UE and/or a BS (e.g., eNB or gNB or TP) and/or a location server (or LMF) which is adapted to perform the above-described mechanism, or any device performing the same operation.

Referring to FIG. 14, the device may include a digital signal processor (DSP)/microprocessor 210 and a radio frequency (RF) module (transceiver) 235. The DSP/microprocessor 210 is electrically coupled to the transceiver 235 and controls the transceiver 235. The device may further include a power management module 205, a battery 255, a display 215, a keypad 220, a SIM card 225, a memory device 230, an antenna 240, a speaker 245, and an input device 250, depending on a designer's selection.

Particularly, FIG. 14 may illustrate a UE including a receiver 235 configured to receive a request message from a network and a transmitter 235 configured to transmit timing transmission/reception timing information to the network. These receiver and transmitter may form the transceiver 235. The UE may further include a processor 210 coupled to the transceiver 235.

Further, FIG. 14 may illustrate a network device including a transmitter 235 configured to transmit a request message to a UE and a receiver 235 configured to receive timing transmission/reception timing information from the UE. These transmitter and receiver may form the transceiver 235. The network may further include the processor 210 coupled to the transceiver 235. The processor 210 may calculate latency based on the transmission/reception timing information.

A processor included in a UE (or a communication device included in the UE) and/or a BS (or a communication device included in the BS) may operate by controlling a memory, as follows.

According to the embodiment, the UE or the BS or the location server may include at least one transceiver, at least one memory, and at least one processor coupled to the at least one transceiver and the at least one memory. The at least one memory may store instructions which cause the at least one processor to perform the following operations.

The communication device included in the UE or the BS or the location server may be configured to include the at least one processor and the at least one memory. The communication device may be configured to include the at least one transceiver or to be coupled to the at least one transceiver without including the at least one transceiver.

The TP and/or the BS and/or any device performing the same operation may be referred to as a network node.

According to one embodiment, one or more processors included in the UE (or one or more processors of a communication device included in the UE) may be configured to receive configuration information.

According to one embodiment, the configuration information may include one or more of system information, scheduling information, channel state information (CSI)-related configuration information, a physical uplink control channel (PUCCH)-related configuration, a physical uplink shared channel (PUSCH)-related configuration, a physical downlink control channel (PDCCH)-related configuration, or a physical downlink shared channel (PDSCH)-related configuration.

According to one embodiment, the one or more processors included in the UE may be configured to communicate a signal based on the configuration information.

According to one embodiment, the signal may be communicated based on orbital angular momentum (OAM) based communication.

According to one embodiment, a sequence generator related to generation of the signal may be initialized based on the OAM state of the OAM-based communication.

According to one embodiment, the configuration information may include configuration information for the OAM-based communication.

According to one embodiment, the configuration information for the OAM-based communication may include one or more of resource configuration for the OAM-based communication or information related to the OAM state.

According to one embodiment, the information related to the OAM state may include one or more of a total number of OAM states of a BS having transmitted the configuration information, a maximum number of orthogonal OAM states of the BS, a set of OAM states of the BS, a subset of OAM states of the BS, the number of ring arrays of the BS, the number of ports of the ring arrays of the BS, or a transmission mode of the BS.

According to one embodiment, the one or more processors included in the UE may be configured to measure the OAM state based on one or more resources for the OAM-based communication.

According to one embodiment, the one or more processors included in the UE may be configured to transmit feedback information including information related to the OAM state.

According to one embodiment, the one or more processors included in the UE may be configured to transmit UE capability information related to whether the UE is capable of supporting the OAM-based communication.

According to one embodiment, wherein, based on that the UE capability information corresponds to the UE supporting the OAM-based communication, the signal may be communicated based on the OAM-based communication.

According to one embodiment, the OAM state may be indicated by four-bit information.

According to one embodiment, based on the signal being a data channel, the data channel may be initialized based on a radio network temporary identifier (RNTI) related to transmission of the data channel, the OAM state, and a parameter that is configured by a higher layer or preconfigured.

According to one embodiment based on the sequence generator corresponding to a Zadoff Chu (ZC) sequence, one or more of a group number or a base sequence number of the ZC sequence may be determined based on the OAM state.

According to one embodiment, based on a value of a most significant bit (MSB) of a specific bit sequence being a specific value, one or more of the group number or base sequence number of the ZC sequence may be determined based on the OAM state.

According to one embodiment, one or more processors included in a network node (or one or more processors of a communication device included in the network node) may be configured to transmit configuration information.

According to one embodiment, the configuration information may include one or more of system information, scheduling information, channel state information (CSI)-related configuration information, a physical uplink control channel (PUCCH)-related configuration, a physical uplink shared channel (PUSCH)-related configuration, a physical downlink control channel (PDCCH)-related configuration, or a physical downlink shared channel (PDSCH)-related configuration.

According to one embodiment, the one or more processors included in the network node may be configured to communicate a signal related to the configuration information.

According to one embodiment, the signals may be communicated based on orbital angular momentum (OAM) based communication.

According to one embodiment, a sequence generator related to generation of the signal may be initialized based on the OAM state of the OAM-based communication.

Specific operations of the processor included in the UE and/or the network node according to the above-described the embodiment may be described and performed based on the details described before.

Unless contradicting each other, the embodiments may be implemented in combination. For example, (the processor included in) the UE and/or the network node according to the embodiment may perform operations in combination of the above-described embodiments, unless contradicting each other.

4.2. Example of Communication System to which the Embodiment is Applied

In the present specification, the embodiment have been mainly described in relation to data transmission and reception between a BS and a UE in a wireless communication system. However, the embodiment is not limited thereto. For example, the embodiment may also relate to the following technical configurations.

The various descriptions, functions, procedures, proposals, methods, and/or operational flowcharts of the embodiment described in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

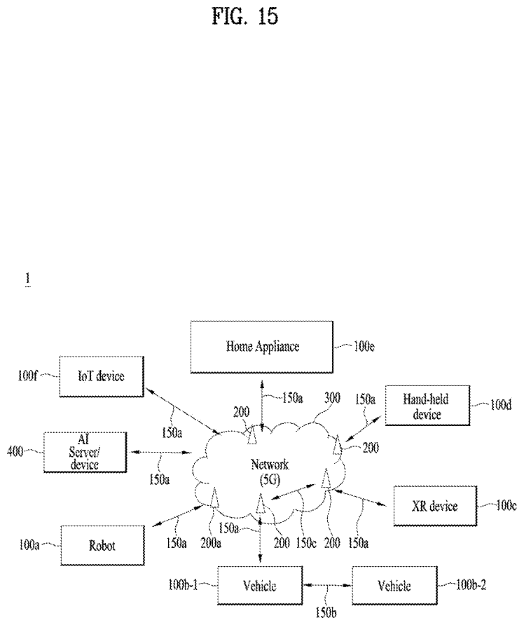

FIG. 15 illustrates a communication system applied to an embodiment.

Referring to FIG. 15, a communication system 1 applied to the embodiment includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an extended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g., relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the embodiment.

Example of Wireless Devices to which the Embodiment is Applied

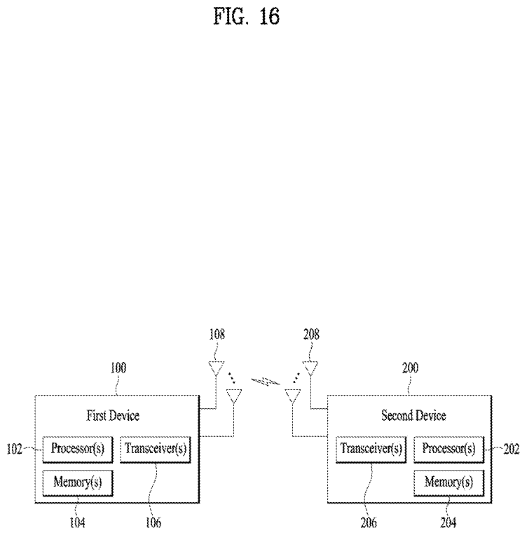

FIG. 16 illustrates exemplary wireless devices applied to an embodiment.

Referring to FIG. 16, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. W1.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the embodiment, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the embodiment, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

According to the embodiment, one or more memories (e.g., 104 or 204) may store instructions or programs which, when executed, cause one or more processors operably coupled to the one or more memories to perform operations according to the embodiment or implementations of the present disclosure.

According to the embodiment, a computer-readable storage medium may store one or more instructions or computer programs which, when executed by one or more processors, cause the one or more processors to perform operations according to the embodiment or implementations of the present disclosure.

According to the embodiment, a processing device or apparatus may include one or more processors and one or more computer memories connected to the one or more processors. The one or more computer memories may store instructions or programs which, when executed, cause the one or more processors operably coupled to the one or more memories to perform operations according to the embodiment or implementations of the present disclosure.

Example of Using Wireless Devices to which the Embodiment is Applied

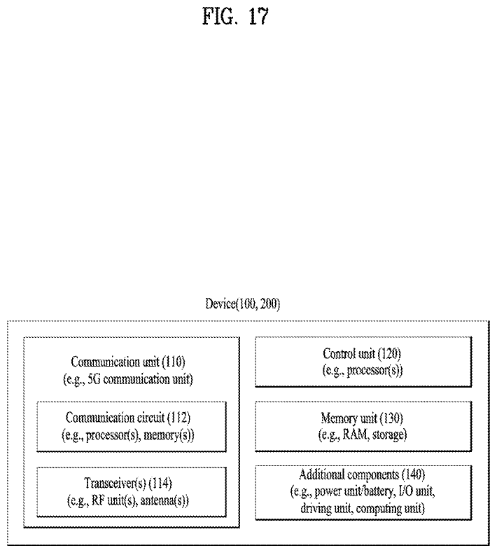

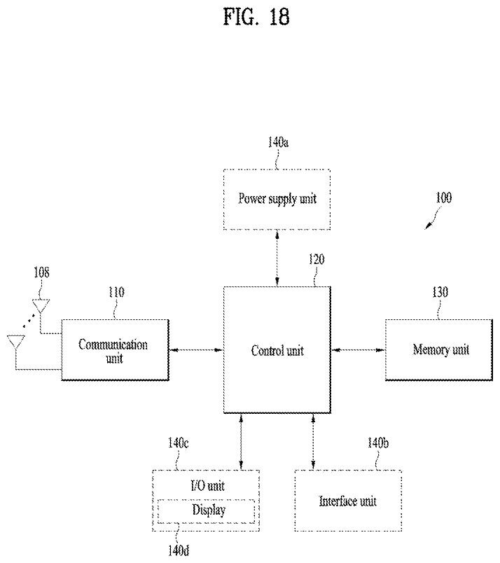

FIG. 17 illustrates other exemplary wireless devices applied to an embodiment. The wireless devices may be implemented in various forms according to a use case/service (see FIG. 18).

Referring to FIG. 17, wireless devices 100 and 200 may correspond to the wireless devices 100 and 200 of FIG. 16 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 16. For example, the transceiver(s) 114 may include the one or more transceivers 106 and 206 and/or the one or more antennas 108 and 208 of FIG. 16. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 15), the vehicles (100b-1 and 100b-2 of FIG. 15), the XR device (100c of FIG. 15), the hand-held device (100d of FIG. 15), the home appliance (100e of FIG. 15), the IoT device (100f of FIG. 15), a digital broadcast terminal, a hologram device, a public safety device, an MTC device, a medicine device, a fintech device (or a finance device), a security device, a climate/environment device, the AI server/device (400 of FIG. 15), the BSs (200 of FIG. 15), a network node, etc. The wireless device may be used in a mobile or fixed place according to a use-example/service.

In FIG. 17, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

Hereinafter, an example of implementing FIG. 17 will be described in detail with reference to the drawings.

Example of Portable Device to which the Embodiment is Applied

FIG. 18 illustrates an exemplary portable device applied to an embodiment. The portable device may be any of a smartphone, a smartpad, a wearable device (e.g., a smartwatch or smart glasses), and a portable computer (e.g., a laptop). A portable device may also be referred to as mobile station (MS), user terminal (UT), mobile subscriber station (MSS), subscriber station (SS), advanced mobile station (AMS), or wireless terminal (WT).

Referring to FIG. 18, a hand-held device 100 may include an antenna unit 108, a communication unit 110, a control unit 120, a memory unit 130, a power supply unit 140a, an interface unit 140b, and an I/O unit 140c. The antenna unit 108 may be configured as a part of the communication unit 110. Blocks 110 to 130/140a to 140c correspond to the blocks 110 to 130/140 of FIG. 17, respectively.

The communication unit 110 may transmit and receive signals (e.g., data and control signals) to and from other wireless devices or BSs. The control unit 120 may perform various operations by controlling constituent elements of the hand-held device 100. The control unit 120 may include an Application Processor (AP). The memory unit 130 may store data/parameters/programs/code/commands needed to drive the hand-held device 100. The memory unit 130 may store input/output data/information. The power supply unit 140a may supply power to the hand-held device 100 and include a wired/wireless charging circuit, a battery, etc. The interface unit 140b may support connection of the hand-held device 100 to other external devices. The interface unit 140b may include various ports (e.g., an audio I/O port and a video I/O port) for connection with external devices. The I/O unit 140c may input or output video information/signals, audio information/signals, data, and/or information input by a user. The I/O unit 140c may include a camera, a microphone, a user input unit, a display unit 140d, a speaker, and/or a haptic module.

As an example, in the case of data communication, the I/O unit 140c may acquire information/signals (e.g., touch, text, voice, images, or video) input by a user and the acquired information/signals may be stored in the memory unit 130. The communication unit 110 may convert the information/signals stored in the memory into radio signals and transmit the converted radio signals to other wireless devices directly or to a BS. The communication unit 110 may receive radio signals from other wireless devices or the BS and then restore the received radio signals into original information/signals. The restored information/signals may be stored in the memory unit 130 and may be output as various types (e.g., text, voice, images, video, or haptic) through the I/O unit 140c.

Example of Vehicle or Autonomous Driving Vehicle to which the Embodiment

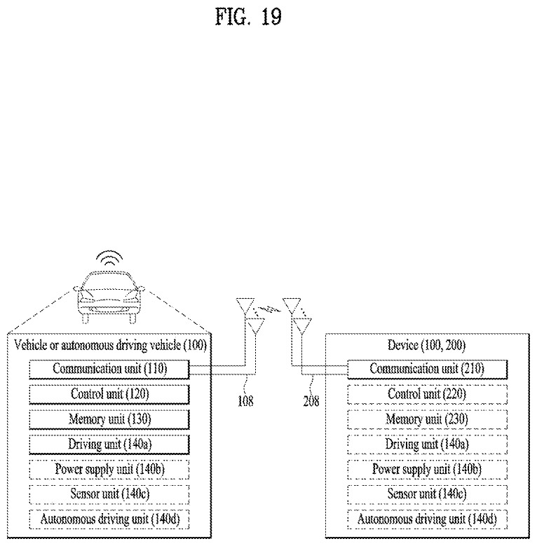

FIG. 19 illustrates an exemplary vehicle or autonomous driving vehicle applied to an embodiment. The vehicle or autonomous driving vehicle may be implemented as a mobile robot, a car, a train, a manned/unmanned aerial vehicle (AV), a ship, or the like.

Referring to FIG. 19, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 20, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an Electronic Control Unit (ECU). The driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

In summary, the embodiment may be implemented through a certain device and/or UE.

For example, the certain device may be any of a BS, a network node, a transmitting UE, a receiving UE, a wireless device, a wireless communication device, a vehicle, a vehicle equipped with an autonomous driving function, an unmanned aerial vehicle (UAV), an artificial intelligence (AI) module, a robot, an augmented reality (AR) device, a virtual reality (VR) device, and other devices.

For example, a UE may be any of a personal digital assistant (PDA), a cellular phone, a personal communication service (PCS) phone, a global system for mobile (GSM) phone, a wideband CDMA (WCDMA) phone, a mobile broadband system (MBS) phone, a smartphone, and a multi-mode multi-band (MMMB) terminal.

A smartphone refers to a terminal taking the advantages of both a mobile communication terminal and a PDA, which is achieved by integrating a data communication function being the function of a PDA, such as scheduling, fax transmission and reception, and Internet connection in a mobile communication terminal. Further, an MM-MB terminal refers to a terminal which has a built-in multi-modem chip and thus is operable in all of a portable Internet system and other mobile communication system (e.g., CDMA 2000, WCDMA, and so on).

Alternatively, the UE may be any of a laptop PC, a hand-held PC, a tablet PC, an ultrabook, a slate PC, a digital broadcasting terminal, a portable multimedia player (PMP), a navigator, and a wearable device such as a smartwatch, smart glasses, and a head mounted display (HMD). For example, a UAV may be an unmanned aerial vehicle that flies under the control of a wireless control signal. For example, an HMD may be a display device worn around the head. For example, the HMD may be used to implement AR or VR.

The wireless communication technology in which the embodiment is implemented may include LTE, NR, and 6G, as well as narrowband Internet of things (NB-IoT) for low power communication. For example, the NB-IoT technology may be an example of low power wide area network (LPWAN) technology and implemented as the standards of LTE category (CAT) NB1 and/or LTE Cat NB2. However, these specific appellations should not be construed as limiting NB-IoT. Additionally or alternatively, the wireless communication technology implemented in a wireless device according to the embodiment may enable communication based on LTE-M. For example, LTE-M may be an example of the LPWAN technology, called various names such as enhanced machine type communication (eMTC). For example, the LTE-M technology may be implemented as, but not limited to, at least one of 1) LTE CAT 0, 2) LTE Cat M1, 3) LTE Cat M2, 4) LTE non-bandwidth limited (non-BL), 5) LTE-MTC, 6) LTE machine type communication, and/or 7) LTE M. Additionally or alternatively, the wireless communication technology implemented in a wireless device according to the embodiment may include, but not limited to, at least one of ZigBee, Bluetooth, or LPWAN in consideration of low power communication. For example, ZigBee may create personal area networks (PANs) related to small/low-power digital communication in conformance to various standards such as IEEE 802.15.4, and may be referred to as various names.

The embodiment may be implemented in various means. For example, the embodiment may be implemented in hardware, firmware, software, or a combination thereof.

In a hardware configuration, the methods according to exemplary embodiments may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the methods according to the embodiment may be implemented in the form of a module, a procedure, a function, etc. performing the above-described functions or operations. A software code may be stored in the memory 50 or 150 and executed by the processor 40 or 140. The memory is located at the interior or exterior of the processor and may transmit and receive data to and from the processor via various known means.

Those skilled in the art will appreciate that the embodiment may be carried out in other specific ways than those set forth herein without departing from the spirit and essential characteristics of the embodiment. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. It is obvious to those skilled in the art that claims that are not explicitly cited in each other in the appended claims may be presented in combination as an embodiment or included as a new claim by a subsequent amendment after the application is filed.

### INDUSTRIAL APPLICABILITY

The embodiment is applicable to various wireless access systems including a 3GPP system, and/or a 3GPP2 system. Besides these wireless access systems, the embodiment is applicable to all technical fields in which the wireless access systems find their applications. Moreover, the proposed method can also be applied to mmWave communication using an ultra-high frequency band.

1. A method performed by a terminal in a wireless communication system, the method comprising:
receiving configuration information, wherein the configuration information comprises one or more of system information, scheduling information, channel state information (CSI)-related configuration information, a physical uplink control channel (PUCCH)-related configuration, a physical uplink shared channel (PUSCH)-related configuration, a physical downlink control channel (PDCCH)-related configuration, or a physical downlink shared channel (PDSCH)-related configuration; and
communicating a signal based on the configuration information,
wherein the signal is communicated based on an orbital angular momentum (OAM) based communication,
wherein a sequence generator related to generation of the signal is initialized based on an OAM state of the OAM based communication.

2. The method of claim 1, wherein the configuration information comprises configuration information for the OAM based communication,
wherein the configuration information for the OAM based communication comprises one or more of a resource configuration for the OAM based communication or information related to the OAM state,
wherein the information related to the OAM state comprises one or more of a total number of OAM states of a base station having transmitted the configuration information, a maximum number of orthogonal OAM states of the base station, a set of OAM states of the base station, a subset of OAM states of the base station, the number of ring arrays of the base station, the number of ports of the ring arrays of the base station, or a transmission mode of the base station.

3. The method of claim 1, further comprising:
measuring the OAM state based on one or more resources for the OAM based communication; and
transmitting feedback information including information related to the OAM state.

4. The method of claim 1, further comprising:
transmitting terminal capability information related to whether the terminal supports the OAM based communication,
wherein, based on that the terminal capability information corresponds to the terminal supporting the OAM based communication, the signal is communicated based on the OAM based communication.

5. The method of claim 1, wherein the OAM state is indicated by 4-bit information.

6. The method of claim 1, wherein, based on the signal being a data channel, the data channel is initialized based on a radio network temporary identifier (RNTI) related to transmission of the data channel, the OAM state, and a parameter that is configured by a higher layer or preconfigured.

7. The method of claim 1, wherein, based on the sequence generator corresponding to a Zadoff Chu (ZC) sequence, one or more of a group number or a base sequence number of the ZC sequence is determined based on the OAM state.

8. The method of claim 7, wherein, based on a value of a most significant bit (MSB) of a specific bit sequence being a specific value, one or more of the group number or base sequence number of the ZC sequence is determined based on the OAM state.

9. A terminal operating in a wireless communication system, the terminal comprising:
a transceiver; and
one or more processors connected to the transceiver,
wherein the one or more processors are configured to:
receive configuration information, wherein the configuration information comprises one or more of system information, scheduling information, channel state information (CSI)-related configuration information, a physical uplink control channel (PUCCH)-related configuration, a physical uplink shared channel (PUSCH)-related configuration, a physical downlink control channel (PDCCH)-related configuration, or a physical downlink shared channel (PDSCH)-related configuration; and
communicate a signal based on the configuration information,
wherein the signal is communicated based on an orbital angular momentum (OAM) based communication,
wherein a sequence generator related to generation of the signal is initialized based on an OAM state of the OAM based communication.

10. The terminal of claim 9, wherein the configuration information comprises configuration information for the OAM based communication,
wherein the configuration information for the OAM based communication comprises one or more of a resource configuration for the OAM based communication or information related to the OAM state,
wherein the information related to the OAM state comprises one or more of a total number of OAM states of a base station having transmitted the configuration information, a maximum number of orthogonal OAM states of the base station, a set of OAM states of the base station, a subset of OAM states of the base station, the number of ring arrays of the base station, the number of ports of the ring arrays of the base station, or a transmission mode of the base station.

11. The terminal of claim 9, wherein the one or more processors are configured to communicate with one or more of: a mobile terminal, a network, or an autonomous vehicle other than a vehicle containing the terminal.

12. A method performed by a base station in a wireless communication system, the method comprising:
transmitting configuration information, wherein the configuration information comprises one or more of system information, scheduling information, channel state information (CSI)-related configuration information, a physical uplink control channel (PUCCH)-related configuration, a physical uplink shared channel (PUSCH)-related configuration, a physical downlink control channel (PDCCH)-related configuration, or a physical downlink shared channel (PDSCH)-related configuration; and
communicating a signal related to the configuration information,
wherein the signal is communicated based on an orbital angular momentum (OAM) based communication,
wherein a sequence generator related to generation of the signal is initialized based on an OAM state of the OAM based communication.

13. A base station operating in a wireless communication system, the base station comprising:
a transceiver; and
one or more processors connected to the transceiver,
wherein the one or more processors are configured to:
transmit configuration information, wherein the configuration information comprises one or more of system information, scheduling information, channel state information (CSI)-related configuration information, a physical uplink control channel (PUCCH)-related configuration, a physical uplink shared channel (PUSCH)-related configuration, a physical downlink control channel (PDCCH)-related configuration, or a physical downlink shared channel (PDSCH)-related configuration; and
communicate a signal related to the configuration information,
wherein the signal is communicated based on an orbital angular momentum (OAM) based communication,
wherein a sequence generator related to generation of the signal is initialized based on an OAM state of the OAM based communication.

14. An apparatus operating in a wireless communication system, the apparatus comprising:
one or more processors; and
one or more memories operably connected to the one or more processors and storing one or more instructions that, when executed, cause the one or more processors to perform operations,
wherein the operations comprise:
receiving configuration information, wherein the configuration information comprises one or more of system information, scheduling information, channel state information (CSI)-related configuration information, a physical uplink control channel (PUCCH)-related configuration, a physical uplink shared channel (PUSCH)-related configuration, a physical downlink control channel (PDCCH)-related configuration, or a physical downlink shared channel (PDSCH)-related configuration; and
communicating a signal based on the configuration information,
wherein the signal is communicated based on an orbital angular momentum (OAM) based communication,
wherein a sequence generator related to generation of the signal is initialized based on an OAM state of the OAM based communication.

15. A non-transitory processor-readable medium storing one or more instructions that cause one or more processors to perform operations,
wherein the operations comprise:
receiving configuration information, wherein the configuration information comprises one or more of system information, scheduling information, channel state information (CSI)-related configuration information, a physical uplink control channel (PUCCH)-related configuration, a physical uplink shared channel (PUSCH)-related configuration, a physical downlink control channel (PDCCH)-related configuration, or a physical downlink shared channel (PDSCH)-related configuration; and
communicating a signal based on the configuration information,
wherein the signal is communicated based on an orbital angular momentum (OAM) based communication,
wherein a sequence generator related to generation of the signal is initialized based on an OAM state of the OAM based communication.
